(19) United States
(12) Patent Application Publication
(10) Pub. No.: US 2017/0167087 A1
(43) Pub. Date: Jun. 15, 2017

(54) COMPACTING DRUM

(71) Applicant: Caterpillar Paving Products Inc., Brooklyn Park, MN (US)

(72) Inventor: Thomas J. Frelich, Albertville, MN (US)

(73) Assignee: Caterpillar Paving Products Inc., Brooklyn Park, MN (US)

(21) Appl. No.: 14/963,627

(22) Filed: Dec. 9, 2015

(51) Int. Cl. E01C 19/23; F15B 11/16; F16H 25/14; E01C 19/26; E02D 3/026

(52) U.S. Cl. CPC E01C 19/235; E01C 19/266; E02D 3/0265; F16H 25/14; F15B 11/16

(57) ABSTRACT

A compacting drum includes an arcuate outer wall having a thickness and a recess formed in the arcuate outer wall. The recess extends into the thickness of the arcuate outer wall and has a central axis. A padfoot is movable, within the recess, between a fist position and a second position along the central axis.

### TECHNICAL FIELD

The present disclosure relates to a compaction machine. More particularly, the present disclosure relates to a compacting drum of the compactor.

### BACKGROUND

Compaction machines or compactors are commonly employed for earth working activities such as construction, road building and landfill. The compactors include a compacting drum. The compacting drum levels or compacts the surface on which it is moved. The compactors are used for in construction industry for the purpose of such as but not limited to road building, and surfaces compacting, and the like. Compacting drums may include a vibratory mechanism for inducing vibratory forces on the material to be compacted. Compactors used for compacting or leveling landfills, sandy or granular surface and heavier soil include a compacting drum having a padfoot surface. Conventionally, the padfoots may be fixedly or removably coupled with the smooth surface of the compacting drums by bolts.

U.S. Pat. No. 5,511,901 discloses a compacting drum construction for a compactor, which includes a primary drum with an arcuate outer surface for contacting the material. A removable shell is provided for changing the outer surface of the primary drum from a planar surface to a padfoot surface. The removable shell is flexibly deformed into frictional engagement with the outer surface of the primary drum. The removable shell requires substantial amount of time for installation, removal and cleaning.

### SUMMARY OF THE DISCLOSURE

In one aspect of the present disclosure, a compacting drum including an arcuate outer wall having a thickness and a recess formed in the arcuate outer wall. The recess extends into the thickness of the arcuate outer wall and has a central axis. A padfoot is movable, within the recess, between a fist position and a second position along the central axis.

In another aspect of the present disclosure, a compactor is disclosed. The compactor includes a frame and a compacting drum rotatably supported on the frame. The compacting drum including an arcuate outer wall having a thickness and a recess formed in the arcuate outer wall. The recess extends into the thickness of the arcuate outer wall and has a central axis. A padfoot is movable, within the recess, between a fist position and a second position along the central axis.

In yet another aspect of the present disclosure, a method of actuating a padfoot in compacting drum is disclosed. The method includes providing the padfoot slidably received within a recess on an arcuate outer wall of the compacting drum. The method includes moving the padfoot in a first position while the padfoot is away from the ground surface. In the first position a top surface of the padfoot is at or below the arcuate outer wall of the compacting drum. The method includes moving the padfoot in a second position while the padfoot is in proximity of the ground surface. In the second position the top surface of the padfoot is above the arcuate outer wall of the compacting drum.

Other features and aspects of this disclosure will be apparent from the following description and the accompanying drawings.

### BRIEF DESCRIPTION OF THE DRAWINGS

FIG. 1 is a perspective view of a compactor having protrusive members, according to an embodiment of the present disclosure;

FIG. 2 illustrates a side view of the compactor having a mechanism associated with the protrusive members, according to an embodiment of the present disclosure;

FIG. 3 illustrates the hydraulic circuit to operate the protrusive members, according to an embodiment of the present disclosure; and

FIG. 4 illustrates a mechanism to operate the protrusive members, according to another embodiment of the present disclosure.

### DETAILED DESCRIPTION

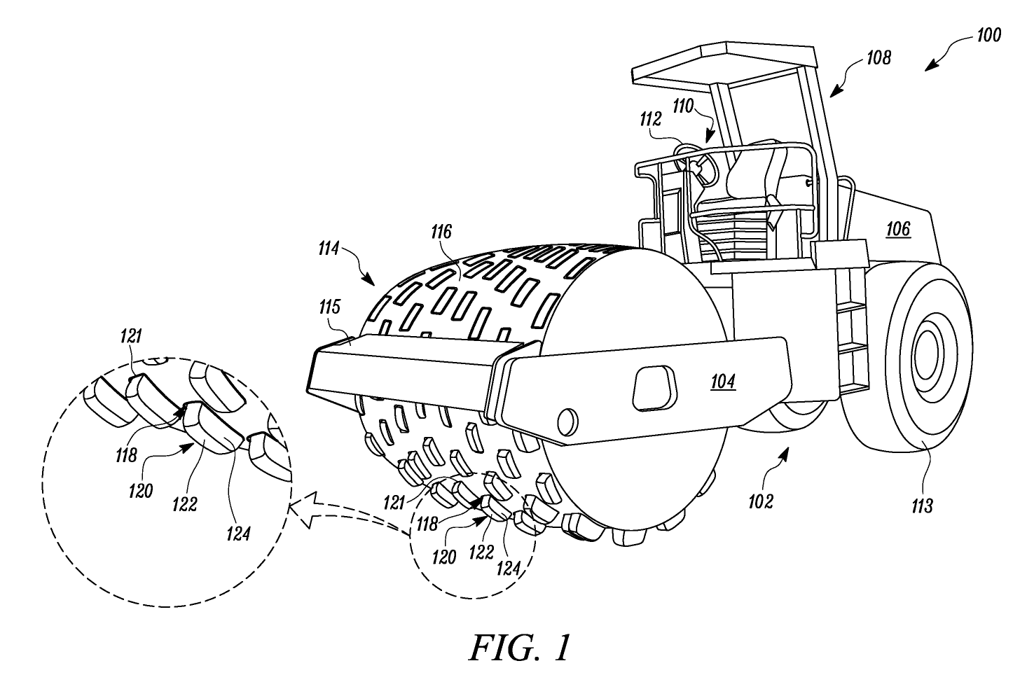

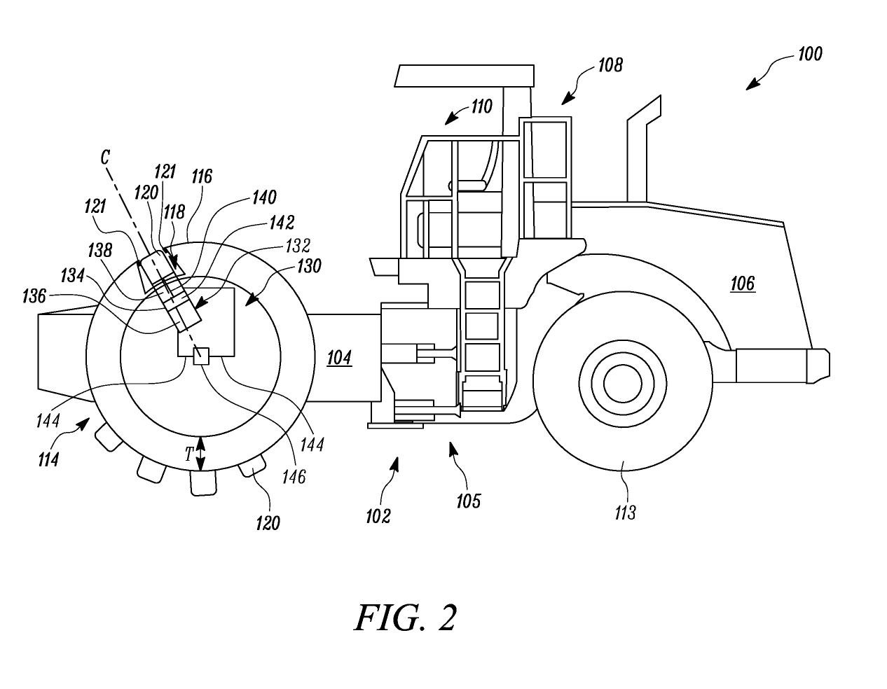

FIG. 1 illustrates a perspective view of a compactor 100, according to an embodiment of the present disclosure. The compactor 100 includes a frame 102 which further includes a front frame 104 and a rear frame 106. The front and rear frames 104, 106 are coupled to each other by an articulated joint 105 (shown in FIG. 2). An operator cabin 108 is mounted on the frame 102 and includes an operator control station 110. The compactor 100 may be controlled by an operator from the operator control station 110 by an input device 112, such as a steering wheel, joysticks, pedals, knobs, switches, or similar control devices. The rear frame 106 of the compactor 100 includes ground engaging members 113. In the illustrated embodiment the ground engaging members 113 are wheels. In alternative embodiments, the ground engaging members 113 may include one or more continuous rubber tracks, track shoes and the like.

The front frame 104 of the compactor 100 rotatably supports a compacting drum 114. The front frame 104 also supports a scraper blade 115. The scraper blade 115 is adapted to maintain contact with an arcuate outer wall 116 of the compacting drum 114. The scraper blade 115 may be appropriately mounted to clean the debris from the arcuate outer wall 116. The outer wall 116 has a thickness ‘T’ (shown in FIG. 2). In an example the thickness ‘T’ may vary over a wide range of drums based on the requirement of leveling.

According to an embodiment of the present disclosure, the compacting drum 114 includes one or more recesses 118. The recesses 118 are disposed over the arcuate outer wall 116 such that the recesses 118 are extending into the thickness ‘T’ of the outer wall 116 and having a central axis C (see FIG. 2). Each recess 118 receives one or more protrusive members 120, hereinafter referred as padfoots 120 that are slidably received within the recesses 118. The padfoots 120 may be disposed in irregular manner or arranged in rows extending from one side to another side of the compacting drum 114. Each of the padfoots 120 is a rigid member that is made of highly durable and wear resistant material, such as steel. In an example, each of the padfoots 120 is a three dimensional solid trapezoid. In another example, the padfoots 120 can be of a cylindrical shape, a cubical shape or any other three dimensional shape. Further, each of the padfoots 120 includes a top surface 122 and side portions 124 and movable between a first position and a second position along the central axis C. In the first position, the padfoots 120 are located entirely within the recess 118 such that the top surfaces 122 of the padfoots 120 conform with or are disposed below the arcuate outer wall 116 of the compacting drum 114. In the second position, the padfoots 120 move at least partially out from the recess 118 such that top surfaces 122 are disposed above the arcuate outer wall 116. Each of the padfoots 120 is adapted to selectively move from the first position to the second position while a portion of the arcuate outer wall 116 approaches the ground surface. In an embodiment, a seal member 121 is provided between each of the padfoots 120 and the recess 118. The seal member 121 prevents any debris or material from entering inside the compacting drum 114 and is configured to clean the padfoot 120 as it moves in the first position. The seal member 121 may be a sleeve made of materials such as nylon, rubber or may have a brush like structure.

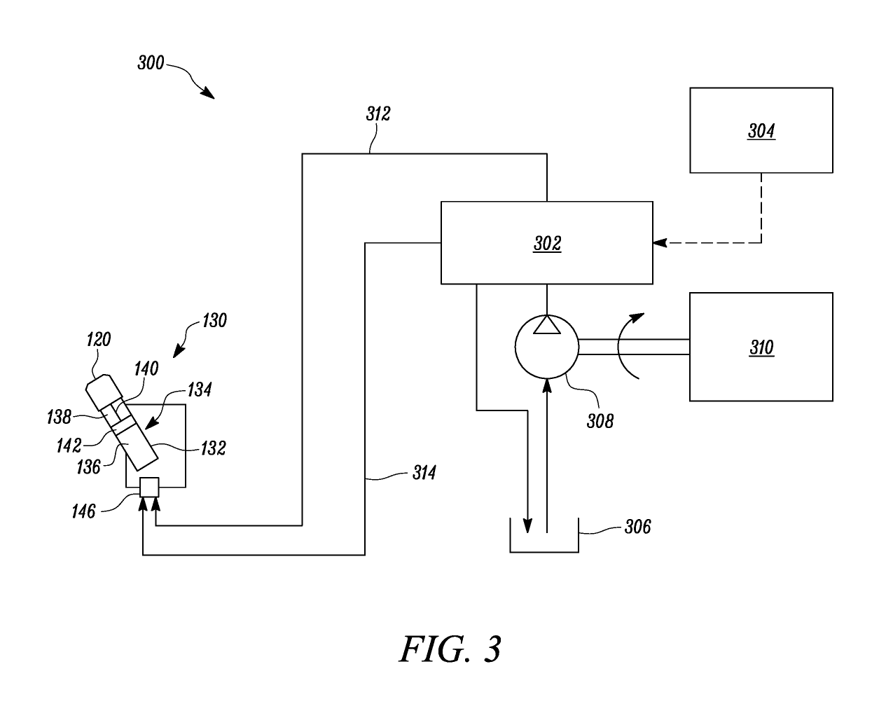

FIG. 2 is a side view of the compactor 100. Referring to FIG. 2 the compacting drum 114 includes a mechanism 130 for actuating the padfoot 120 from the first position to the second position and vice-versa. The mechanism 130 includes a double acting hydraulic cylinder 132 disposed radially within the compacting drum 114. The double acting hydraulic cylinder 132 includes a cylindrical housing 134. The cylindrical housing 134 includes a head end portion 136 and a rod end portion 138 separated by a piston 142 which is disposed in the cylindrical housing 134. The cylindrical housing 134 further includes a rod 140. The rod 140 is coupled to the padfoot 120 at one end and to the piston 142 at another end thereof The piston 142 is configured to move the rod 140 within the cylindrical housing 134. The cylindrical housing 134 also includes sensor assemblies and hydraulic ports (not shown). The sensor assemblies are used to sense the position of the piston 142. Further, the hydraulic ports may allow the ingress and egress of fluid into and from the head end portion 136 and the rod end portion 138 of the cylindrical housing 134. The mechanism 130 further includes a hydraulic manifold 146. The hydraulic manifold 146 is connected to the double acting hydraulic cylinder 132, via the hydraulic lines 144. Further, the hydraulic manifold 146 is adapted to receive pressurized hydraulic fluid from a hydraulic circuit that is further explained in conjunction with FIG. 3.

Referring to FIG. 3, a hydraulic circuit 300 to operate the padfoot 120 is depicted. The hydraulic circuit 300 includes a hydraulic control valve 302. In an example the hydraulic control valve 302 is a four way-three position hydraulic valve. The hydraulic control valve 302 is controlled manually or electronically be external means. The external means is a controller 304. The controller 304 is connected to one or more sensors (not shown). The sensors are configured to monitor the position of the hydraulic control valve 302. The hydraulic control valve 302 is fluidly connected to a tank 306, which acts as a fluid reservoir, via a pump 308. Further, the hydraulic control valve 302 selectively connects the tank 306, the pump 308 and the hydraulic manifold 146. The pump 308 is configured to receive power from a power source 310. The power source 310 may be an engine such as internal combustion engine, an electric battery or any other power source known in the art. It may be contemplated that the three positions of the hydraulic control valve 302 may include two positions that fluidly connect the head end portion 136 and the rod end portion 138 of the cylindrical housing 134 to a high pressure line 312 and a discharge line 314, respectively and vice versa. Further, a third position of the hydraulic control valve 302 disconnects the manifold 146 from the tank 306 and the pump 308.

The controller 304, may also be known as a control module or a controller, may take many forms including a computer based system, a microprocessor based system including a microprocessor, a microcontroller associated electronic circuitry such as input/output circuitry, analog circuits or programmed logic arrays, as well as associated memory, or any other control type circuit or system. The controller 304 may include memory for storage of a control program for operating and controlling the hydraulic circuit 300 of the present disclosure and other memory for temporary storage of information.

According to an embodiment, the controller 304 may also be capable of sensing the position of the padfoots 120 based on the sensors associated with the compacting drum 114. The sensors may include slope or inclination sensors for measuring the angle of the padfoots 120 relative to the ground surface and indicating while the padfoots 120 are approaching the ground surface. The controller 304 can therefore be programmed to sense and recognize appropriate signals from the sensor assemblies associated with the cylindrical housing 134 to determine and control the position of the piston 142 within the cylindrical housing 134. Further, the controller 304 can determine the rate of movement or velocity of piston 142. The controller 304 may be capable of controlling the movement of the piston 142 by controlling the hydraulic control valve 302. The controller 304 may also be capable of selectively switching the positions of the padfoots 120 from the first position to the second position, while the padfoots 120 are approaching the ground surface.

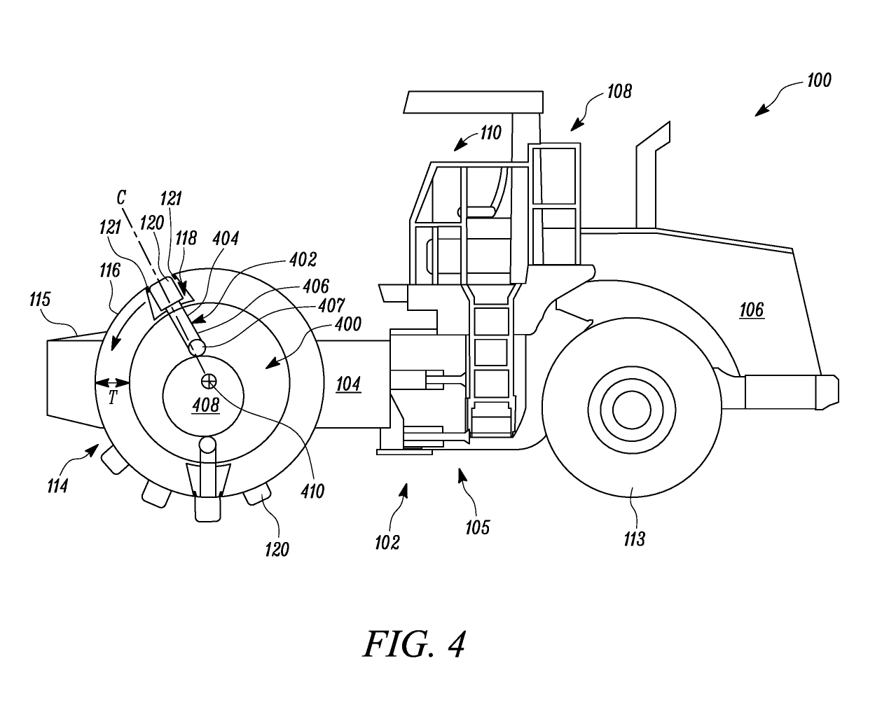

FIG. 4 illustrates another embodiment, depicting a mechanism 400 to operate the padfoots 120. The mechanism 400 includes a follower rod 402. The follower rod 402 is disposed radially within the compacting drum 114. The follower rod 402 includes a first end 404 and a second end 406. The first end 404 is proximate to the arcuate outer wall 116 and the second end 406 is distal to the arcuate outer wall 116. The first end 404 of the follower rod 402 is coupled to the padfoot 120. The second end 406 of the follower rod 402 may include a roller 407 in contact with an eccentric shaft 408. The eccentric shaft 408 is offset from a geometric centre 410 of the compacting drum 114. Further, the second end 406 may be provided with a biasing element (not shown), for example a spring. The biasing element is configured to bias the follower rod 402 towards the geometric center 410 of the compacting drum 114.

The eccentric shaft 408 is configured to displace the follower rod 402 along the radial direction of the compacting drum 114. The eccentric shaft 408 is fixedly disposed on the front frame 104 and the compacting drum 114 is rotatable around it. In another embodiment the eccentric shaft 408 may be commonly centered with the compacting drum 114 with an eccentric lobe. Industrial Applicability

During the operation of the compactor 100, with reference to an embodiment shown in FIG. 3, the operator moves the compacting drum 114 over the surface that requires compaction. The cylindrical housing 134 has fluid filled within the rod end portion 138 such that the padfoot 120 is in the first position. The controller 304 is programmed to detect the position of the padfoot 120 relative to the ground surface. When the controller 304 senses that the padfoot 120 is proximate to the ground surface, the controller 304 signals the hydraulic control valve 302 to supply pressurized fluid from the tank 306, via the pump 308, into the head end portion 136 of the cylinder housing 134. The pressurized fluid pushes the piston 142 to move outwards thereby pushing the padfoot 120 in the second position. The padfoot 120 in the second position presses the ground surface to compact.

Further, when the controller 304 senses that that the padfoot 120 is moving away from the ground surface, the controller 304 signals the hydraulic control valve 302 to supply pressurized fluid from the tank 306 via the pump 308 into the rod end portion 138 of the cylinder housing 134. The pressurized fluid retracts the piston 142 to move inwards thereby pushing the padfoot 120 in the first position. The seal member 121 cleans the soil or earth that may be carried by the padfoot 120 that move away from the ground surface after compaction.

In another embodiment, with reference to an embodiment shown in FIG. 4, when the operator moves the compacting drum 114 over the ground surface that requires compaction, the follower rod 402 slides over the eccentric shaft 408. As the follower rod 402 slides over the eccentric shaft 408, which is offset, the follower rod 402 pushes the padfoot 120 in the second position. The present disclosure allows selective engaging of the padfoot 120 thereby aiding in cleaning of the padfoot 120 therethrough. Further, in another embodiment, the eccentric shaft 408 may be selectively positioned by any means such as a controller 304, or a lever and the like as per the requirement of the padfoot 120. According to the present disclosure, as the padfoot 120 in second position makes it difficult to clean the outer wall 116 of the compacting drum 114 using the blade type scraper 115 (see FIG. 1), thus using the mechanisms 130 or 400 the padfoot 120 can be pulled back into the compacting drum 114 to provide a smooth drum surface which is much easier to clean all the material using the scraper 115.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A compacting drum comprising:
an arcuate outer wall having a thickness;
a recess formed in the arcuate outer wall and extending into the thickness and having a central axis; and
a padfoot movable between a first position and a second position along the central axis.

2. The compacting drum of claim 1, wherein in the first position the padfoot is located entirely within the recess and in the second position at least a portion of the padfoot extends beyond the recess.

3. The compacting drum of claim 1, wherein the padfoot includes a top surface, and wherein in the first position, the top surface of the padfoot is at or below the arcuate outer wall of the compacting drum and in the second position, the top surface of the padfoot is above the arcuate outer wall of the compacting drum.

4. The compacting drum of claim 1 further comprising a mechanism adapted to move the padfoot between the first position and the second position.

5. The compacting drum of claim 4, wherein the mechanism includes:
a double acting hydraulic cylinder disposed radially within the compacting drum, the double acting hydraulic cylinder includes:
a cylindrical housing;
a piston disposed within the cylindrical housing; and
a rod connected to the piston at one end and connected to the padfoot at another end thereof; and
a hydraulic manifold connected to the cylindrical housing via hydraulic lines and adapted to receive pressurized hydraulic fluid from a hydraulic circuit.

6. The compacting drum of claim 4, wherein the mechanism includes:
a follower rod disposed radially within the compacting drum, the follower rod having a first end and a second end, the first end coupled to the padfoot; and
an eccentric shaft disposed offset from a geometric center of the compacting drum, the second end of the follower rod is in contact with the eccentric shaft.

7. The compacting drum of claim 6, wherein the second end of the follower rod includes a roller in contact with the eccentric shaft.

8. The compacting drum of claim 1 further comprising a seal member provided between the padfoot and the recess.

9. A compactor comprising:
a frame; and
a compacting drum rotatably supported on the frame, the compacting drum including:
an arcuate outer wall having a thickness;
a recess formed in the arcuate outer wall and extending into the thickness and having a central axis; and
a padfoot movable between a first position and a second position along the central axis.

10. The compactor of claim 9, wherein in the first position the padfoot is located entirely within the recess and in the second position at least a portion of the padfoot extends beyond the recess.

11. The compactor of claim 9, wherein the padfoot includes a top surface, and wherein in the first position, the top surface of the padfoot is at or below the arcuate outer wall of the compacting drum and in the second position, the top surface of the padfoot is above the arcuate outer wall of the compacting drum.

12. The compactor of claim 9, wherein the compacting drum further including a mechanism adapted to move the padfoot between the first position and the second position.

13. The compactor of claim 12, wherein the mechanism includes:
a double acting hydraulic cylinder disposed radially within the compacting drum, the double acting hydraulic cylinder includes:
a cylindrical housing;
a piston disposed within the cylindrical housing; and
a rod connected to the piston at one end and connected to the padfoot at another end thereof; and
a hydraulic manifold connected to the cylindrical housing via hydraulic lines and adapted to receive pressurized hydraulic fluid from a hydraulic circuit.

14. The compactor of claim 12, wherein the mechanism includes:
a follower rod disposed radially within the compacting drum, the follower rod having a first end and a second end, the first end coupled to the padfoot; and
an eccentric shaft disposed offset from a geometric center of the compacting drum, the second end of the follower rod is in contact with the eccentric shaft.

15. The compactor of claim 14, wherein the second end of the follower rod includes a roller in contact with the eccentric shaft.

16. A method of actuating a padfoot in a compacting drum, the method comprising:
providing the padfoot slidably received within a recess on an arcuate outer wall of the compacting drum;
moving the padfoot in a first position while the padfoot is away from the ground surface, in the first position a top surface of the padfoot is at or below the arcuate outer wall of the compacting drum; and
moving the padfoot in a second position while the padfoot is in proximity of the ground surface, in the second position the top surface of the padfoot is above the arcuate outer wall of the compacting drum.

17. The method of claim 16, wherein moving the padfoot in the first position includes retracting the padfoot inwards into the recess under an action of pressurized hydraulic fluid.

18. The method of claim 16, wherein moving the padfoot in the second position includes pushing the padfoot outward from the recess under an action of pressurized hydraulic fluid.

19. The method of claim 16, wherein moving the padfoot in the first position includes retracting the padfoot inwards into the recess by a follower rod and an eccentric shaft.

20. The method of claim 16, wherein moving the padfoot in the second position includes pushing the padfoot outward from the recess by a follower rod and an eccentric shaft.
